(19) United States
(12) Patent Application Publication
(10) Pub. No.: US 2010/0129707 A1
(43) Pub. Date: May 27, 2010

(54) ELECTROCHEMICAL CELL

(75) Inventors: Masatoshi Uchida, Fuchu-shi (JP); Hiroyuki Takei, Onomichi-shi (JP)

Correspondence Address: DAY PITNEY LLP, 7 TIMES SQUARE, NEW YORK, NY, 10036-7311, US

(73) Assignee: KITAGAWA SEIKI KABUSHIKI KAISHA, Hiroshima (JP)

(21) Appl. No.: 12/624,771

(22) Filed: Nov. 24, 2009

(30) Foreign Application Priority Data
Nov. 26, 2008 (JP) 2008-300466

(51) Int. Cl. H01M 2/00

(52) U.S. Cl. 429/163

(57) ABSTRACT

An electrochemical cell has a first metal case, a second metal case and a gasket. The first metal case has a first disk portion and a first wall. The second metal case has a second disk portion and a second wall. The gasket is interposed between the first metal case and the second metal case. A bottom surface of the gasket is formed such that one of the outer edge and the inner edge of the bottom surface is spaced from the second disk portion by a predetermined distance. The bottom surface of the gasket inclines with respect to the second disk portion. When an end portion of the second wall is bent toward the first wall, the bottom surface of the gasket contacts the second disk portion.

### CROSS-REFERENCE TO RELATED APPLICATION

This application claims priority under 35 U.S.C. §119 from Japanese Patent Application No. 2008-300466 filed on Nov. 26, 2008. The entire subject matter of the application is incorporated herein by reference.

### BACKGROUND

1. Technical Field

Aspects of the present invention relate to an electrochemical cell which is configured to have a pair of tub-shaped metal cases which are coupled with an annular gasket interposed therebetween.

2. Related Art

Conventionally, small electrochemical cells (such as a lithium battery, an electric double layer capacitor or the like) are widely used as a main power supply or an auxiliary power supply for portable electronics products (such as mobile communication devices, notebook PCs, and the like).

An example of such an electrochemical cell is disclosed in Japanese Patent Provisional Publication No. 2005-123017 (hereinafter, referred to as '017 publication). FIG. 4 is a cross-sectional partial side view of the conventional electrochemical cell disclosed in '017 publication. The electrochemical cell 11 disclosed in ‘017 publication has a so-called button-shaped appearance as a whole, which has a pair of circular tub-shaped metal cases 13 and 14, respectively having circular faces 13b and 14b, and walls 13a and 14a extending vertically from peripheral ends of the circular face portions, are coupled with an annular gasket 18, which is made of insulating material (e.g., resin), interposed therebetween. The metal cases 13 and 14 serve as electrode terminals of the electrochemical cell, respectively.

The conventional electrochemical cell is configured such that a diameter of the upper metal case 13 is smaller than that of the lower metal case 14. A circular groove 18a is formed along a central portion of an annular upper surface of the gasket 18, and a nose portion 13c of the wall 13a of the upper metal case 13 is inserted into the circular groove 18a of the gasket 18, which is placed along an inner wall of the wall 14a of the lower metal case 14 (FIG. 4A). In a state where the upper metal case 13, the lower metal case 14 and the gasket 18 are arranged as shown in FIG. 4A, there is a clearance between a bottom surface 18b of the gasket 18 and the upper (inner) surface of the circular face 14b. After arranging each component as shown in FIG. 4A, the wall 14a is bent inwardly. As the wall 14a is bent (see FIG. 4B), the gasket 18 is pressed so that the bottom surface 18b tightly contacts the inner surface of the lower metal case 14, and the upper metal case 13 is downwardly pushed toward the lower metal case 14. Further, the nose portion 13c is pressed to tightly contact the bottom surface of the groove 18a.

In such a conventional configuration, before the wall 14a is bent (see FIG. 4A), the clearance S₁₁ is filled with electrolytic solution. When the wall 14a is bent (see FIG. 4B), most of the electrolytic solution remained in the clearance S₁₁ moves toward a central portion of the lower metal case 14. However, a part of the electrolytic solution may move oppositely (i.e., to a corner portion where the wall 14a meets the lower face 14b of the lower metal case 14). The electrolytic solution moved to the corner portion of the lower metal case 14 may be raised when heat is applied in an aging process or a mounting process and may leak from an end portion 14c of the wall 14a.

According to the conventional configuration, the leakage of the electrolytic solution is prevented by applying sealant such as asphalt primer to an outer surface 18c of the gasket 18, i.e., a surface facing the metal case 14. However, if a thickness of the sealant is uneven, there still remains a problem that the electrolyte solution is likely to leak when the heat is applied in the aging process and the mounting process. In general, in order to apply the sealant uniformly, it is preferable to decrease a viscosity of the sealant by adding solvent into the sealant. However, when the solvent-rich sealant is applied to the gasket 18, the gasket 18 may be dissolved by the solvent and deformations, hardening or cracks of the gasket may occur. Thus, even if the solvent-rich sealant is used, there still remains a problem that the electrolytic solution may leak. Because of this, in a production process of the conventional electric double layer capacitor, a special means for applying the sealant, which includes a small amount of the solvent (i.e., high viscosity sealant), to the gasket 18 uniformly has been used.

### SUMMARY

In consideration of the above problems, aspects of the present invention provide an improved electrochemical cell provided with a gasket having a good sealing performance without using sealant.

According to aspects of the present invention, there is provided an electrochemical cell has a first metal case, a second metal case and a gasket. The first metal case has a first disk portion and a first wall protruding from a peripheral end of the first disk portion. The second metal case has a second disk portion and a second wall protruding from a peripheral end of the second disk portion, a diameter of the second disk portion is larger than a diameter of the first disk portion, and the first metal case is accommodated in the second metal case such that the first wall faces the second disk portion. The gasket has an annular upper surface, an annular bottom surface and a predetermined thickness, and the gasket is interposed between the first metal case and the second metal case when the first metal case is accommodated in the second metal case. Further, an outer circumference surface of the gasket contacts the second wall and a bottom surface of the annular gasket faces the second disk portion, a circular groove is formed on the upper surface along its annular shape to receive an end portion of the first wall when the first metal case is accommodated in the second metal case, the bottom surface of the gasket is formed such that one of an outer edge and an inner edge of the bottom surface contacts the second disk portion and the other of the outer edge and the inner edge of the bottom surface is spaced from the second disk portion by a predetermined distance, the bottom surface of the gasket inclines with respect to the second disk portion, and when an end portion of the second wall is bent toward the first wall with the first metal case being accommodated in the second metal case, the gasket is compressed between the first wall and the second wall and the bottom surface of the gasket contacts the second disk portion.

### BRIEF DESCRIPTION OF THE ACCOMPANYING DRAWINGS

FIG. 1 is a perspective view showing an electric double layer capacitor (EDLC) according to an embodiment of the present invention.

FIG. 2 is a cross-sectional side view showing the EDLC according to the embodiment of the present invention.

FIG. 3A is an enlarged cross-sectional side view showing a near-field region of a gasket used in the EDLC according to the embodiment of the present invention before a lower metal case is crimped.

FIG. 3B is an enlarged cross-sectional side view showing the near-field region of the gasket used in the EDLC according to the embodiment of the present invention after the lower metal case is crimped.

FIG. 4A is an enlarged cross-sectional side view showing a near-field region of a gasket used in a conventional EDLC before a lower metal case is crimped.

FIG. 4B is an enlarged cross-sectional side view showing the near-field region of the gasket used in the conventional EDLC after the lower metal case is crimped.

FIG. 5 is an enlarged cross-sectional side view showing a near-field region of a gasket used in an EDLC according to a modified embodiment of the present invention before a lower metal case is crimped.

FIG. 6 is an enlarged cross-sectional side view showing a near-field region of a gasket used in an EDLC according to a modified embodiment of the present invention before a lower metal case is crimped.

FIG. 7 is an enlarged cross-sectional side view showing a near-field region of a gasket used in an EDLC according to a modified embodiment of the present invention before a bottom metal case is crimped.

FIG. 8 is an enlarged cross-sectional side view showing a near-field region of a gasket used in an EDLC according to a modified embodiment of the present invention before a lower metal case is crimped.

### DETAILED DESCRIPTION

Hereinafter, an exemplary embodiment according to aspects of the present invention will be described with reference to the accompany drawings.

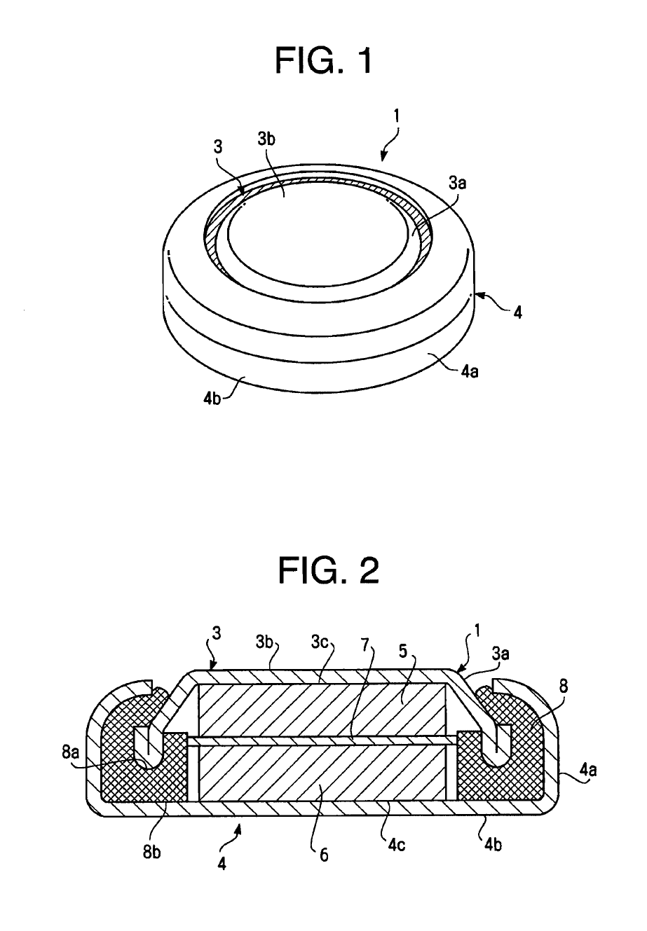

FIG. 1 is a perspective view showing an electric double layer capacitor (EDLC) 1 according to the exemplary embodiment of the present invention. The EDLC 1 is a type of an electrochemical cell which accumulates electric energy using electric double layers formed at a boundary between a solid and electrolytic solution.

As shown in FIG. 1, the EDLC 1 according to the exemplary embodiment has a so-called button-shaped appearance, and a top surface and a bottom surface thereof correspond to a cathode and an anode, respectively. The EDLC 1 is formed by coupling an upper metal case 3 with a lower metal case 4. The upper metal case 3 has an upper disk portion 3b and a wall 3a projecting downward from a peripheral end of the upper disk portion 3b. As shown in FIG. 2, the wall 3a is slightly flared. Thus, the upper metal case 3 has a shape of a truncated cone viewed from above and a downward tub-shaped appearance view from below.

The lower metal case 4 is provided with a lower disk portion 4b, of which a diameter is larger than that of the upper disk portion 3b, and a wall 4a projecting vertically and upwardly from a peripheral end of the lower disk portion 4b. Thus, the lower metal case 4 has an upward tub-shaped appearance as a whole.

FIG. 2 is a cross-sectional view of the EDLC 1.

As shown in FIG. 2, all components such as electrodes are accommodated in a space enclosed by the upper metal case 3 and the lower metal case 4. Specifically, an upper electrode 5 and a lower electrode 6 respectively contact the inner surface 3c of the upper disk portion 3b and the inner surface 4c of the lower disk portion 4b of the lower metal case 4.

A separator 7 is placed between the upper electrode 5 and the lower electrode 6 to prevent a short circuit caused by contact therebetween. A diameter of the lower electrode 6 is equal to or slightly larger than that of the upper disk portion 3b of the upper metal case 3. The wall 3a of the upper metal case 3 is flared, that is, formed such that a diameter thereof is larger at a lower portion than a higher portion. Thus, an inside diameter of the wall 3a at a height of a top face of the lower electrode 6 is sufficiently larger than an outside diameter of the lower electrode 6, and the upper metal case 3 does not contact the lower electrode 6.

The upper electrode 5 and the lower electrode 6 are respectively impregnated with the electrolytic solution. As a pair of electrodes impregnated with the electrolytic solution are opposed to each other with the separator 7 located therebetween, the EDLC is configured thereby.

A gasket 8 is interposed between the upper metal case 3 and the lower metal case 4. The gasket 8 is made of resin. The gasket 8 prevents the short circuit caused by contact of the upper metal case 3 and the lower metal case 4, and prevents the leakage of the electrolytic solution that is filled in a clearance between the upper metal case 3 and the lower metal case 4.

As shown in FIG. 2, the gasket 8 is a ring-shaped member, and a groove 8a is formed on a top surface of the gasket 8, at the middle portion of a radial width of the gasket 8.

As a circumference surface of the gasket 8 is pressed to tightly contact an inner circumference surface of the wall 4a, and the wall 3a is fitted in the groove 8a, the inner circumference surface of the wall 4a and an inner circumference surface of the wall 3a are tightly attached to each other through the gasket 8. Due to such a configuration, the leakage of the electrolytic solution and the contact of the upper metal case 3 and the lower metal case 4 are prevented. Furthermore, after the upper metal case 3 has been attached to the lower metal case 4, as a top portion of the wall 4a of the lower metal case 4 is bent toward a central portion of the lower disk portion 4b, i.e., the lower metal case 4 is crimped, the gasket 8 is pressed to such that the bottom surface 8b tightly contacts the lower metal case 4.

In addition, as the top portion of the wall 4a is bent inwardly, the upper metal case 3 is downwardly pushed by the wall 4a of the lower metal case 4. Therefore, the gasket 8 is nipped by an end portion 3c of the wall 3a and the lower disk portion 4b at a place of the groove 8a, and the gasket 8 is pressed to tightly contact the upper metal case 3 and the lower disk portion 4b. As a result, the leakage of the electrolytic solution is prevented. Furthermore, due to the crimping of the wall 4a of the lower metal case 4, since the gasket 8 is pressed between a top end of the wall 4a and the wall 3a, a sealing effect between the upper metal case 3 and the lower metal case 4 is enhanced.

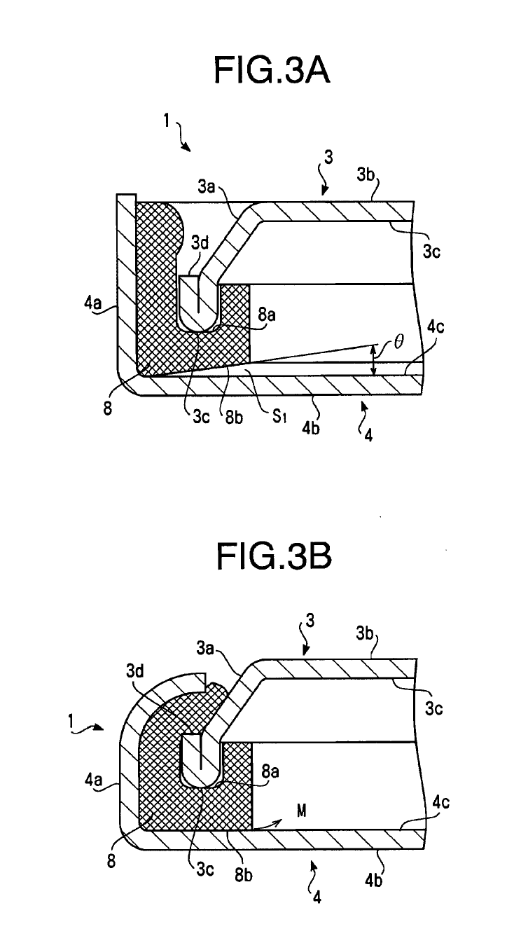

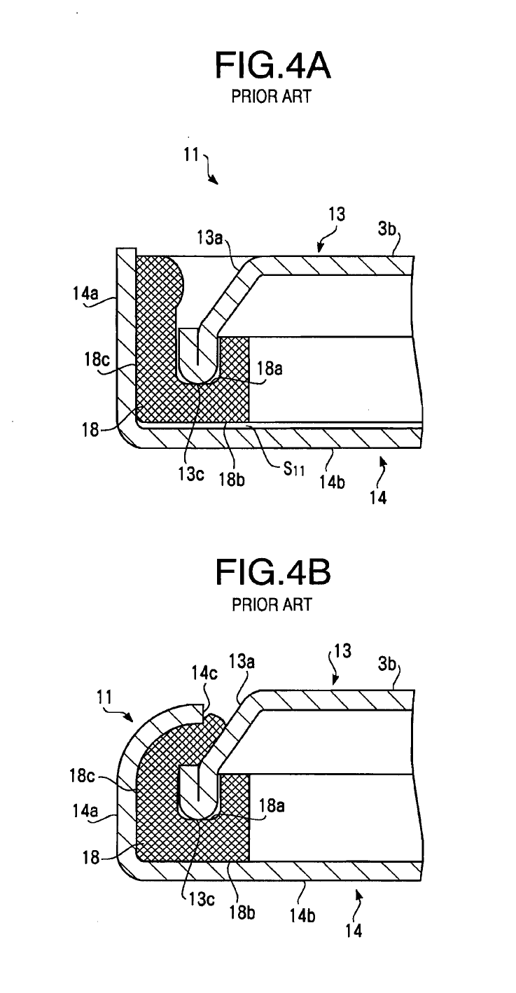

In the exemplary embodiment, in a neutral state (i.e., before the wall 4a is crimped), the bottom surface 8b of the gasket 8 inclines such that an outer edge of the gasket 8 contacts the lower disk portion 4b while an inner edge of the gasket 8 is spaced from the lower disk portion 4b by a predetermined distance, in order to enhance a contact between the gasket 8 and the lower disk portion 4b of the lower metal case 4. Namely, a distance from the lower disk portion 4b to the bottom surface 8b of the gasket 8, in a plane which includes a diameter of the gasket 8 and is perpendicular to the lower disk portion 4b increases, from the peripheral end of the lower disk portion 4b to an inner portion, at a constant rate, so that a truncated cone-shaped space S1 is formed between the bottom surface 8b and the lower disk portion 4b as shown in FIG. 3A.

Hereinafter, configurations of the gasket 8 will be described. FIGS. 3A and 3B are enlarged cross-sectional views showing an area in which the gasket 8 contacts the lower disk portion 4b. FIG. 3A shows a state before the wall 4a is crimped, and FIG. 3B shows a state after the wall 4a is crimped. The electrodes 5, 6 and the separator 7 are omitted in FIGS. 3A and 3B to show an appearance of the gasket 8 clearly. When the top portion of the wall 4a is bent toward the inside of the lower metal case 4, i.e., toward the wall 3a, the wall 3a of the upper metal case 3 is pushed downward by an upper portion of the gasket 8. As shown in FIG. 3A, an end portion of the wall 3a is folded outward, i.e., toward the wall 4a, to form a turnback portion. At the trunback portion of the wall 3a, a step portion 3d of which the top surface is substantially parallel to the inner surface 4c of the lower disk portion 4b is formed. In the exemplary embodiment, when the top portion of the wall 4a is bent inward, the step portion 3d is pushed down via the gasket 8, and a bottom surface of the groove 8a is pushed down by an end portion 3c of the turnback portion, thereby the upper metal case 3 is pushed downward. Due to the step portion 3d of which the top surface is substantially parallel to the inner surface 4c of the lower disk portion 4b, a force component perpendicular to the step portion 3d, i.e., a force to push the upper metal case 3 toward the lower metal case 4 can be applied effectively to the upper metal case 3.

In addition, as shown in FIG. 3A, the bottom surface 8b inclines with respect to the inner surface 4c of the disk portion 4b such that a truncated cone-shaped space S1 is formed between the bottom surface 8b and the inner surface 4c of the disk portion 4b before the top portion of the wall 4a is bent. When the wall 4a is crimped, the gasket 8 deforms such that bottom surface 8b of the gasket 8 tightly contacts the inner surface 4c of the lower disk portion 4b as shown in FIG. 3B. With this deformation, the electrolytic solution filling the truncated cone-shaped space S1 is extruded from the space Si between the bottom surface 8b and the inner surface 4c, and is moved toward a central portion of the lower metal case 4 as shown with an arrow M in FIG. 3B. Thus, the electrolytic solution does not intrude in the spec S1 and thus does not leak from a portion where the gasket 8 contacts the inner surface of the wall 4a.

In the present embodiment, the distance from the inner surface 4c of the lower disk portion 4b to the bottom surface 8b increases, when measured along a radius of the inner surface 4c of the lower disk portion 4b, at a substantially constant rate. Specifically, the distance is zero at the peripheral end of the upper surface of the lower disk portion 4b, the distance from the inner surface 4c of the lower disk portion 4b to the inner end of the bottom surface 8b, and the distance increases therebetween. As shown in FIG. 3A, on a plane perpendicular to the inner surface 4c of the lower disk portion 4b and including a radius of the inner surface 4c of the lower disk portion 4b, the bottom surface 8b and the inner surface 4c of the lower disk portion 4b are represented by lines, which form an elevation angle θ before the end portion of the lower wall 4a is bent. Namely, the bottom surface 8b at the neutral state has an inclined surface which inclines outward at the elevation angle θ. When the elevation angle θ is within a range of 1° and 10°, inclusively, the leakage of the electrolytic solution is prevented effectively. It is noted that the present invention is not limited to the configuration of the exemplary embodiment described above. Rather, it should be appreciated that the configuration can be modified in various ways without departing from the scope of the invention. For example, the elevation angle θ may exceed 10° if the bottom surface 8b tightly contacts the inner surface 4c of the lower disk portion 4b when the end portion of the wall 4a is bent.

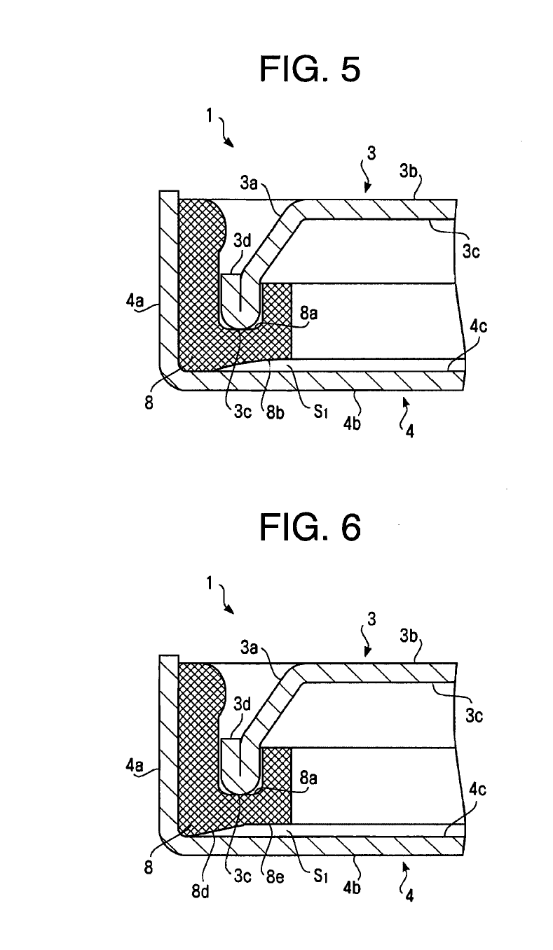

In addition, in the exemplary embodiment, the bottom surface 8b at the neutral state has the inclined surface which inclines outward at a predetermined constant elevation angle θ. However, the present invention is not limited to such a configuration. For example, as shown in FIGS. 5 and 6, the bottom surface 8b at the neutral state may have another type of a curved surface. For example, the bottom surface 8b may have a spherical surface, an ellipsoidal surface, a paraboloidal surface, a hyperbolic surface or the like.

Furthermore, in the exemplary embodiment, a whole area of the bottom surface 8b is configured with the inclined surface, but the present invention is not limited to such a configuration. For example, as shown in FIG. 6, an inclined surface 8d may be configured in a peripheral area of the bottom surface of the gasket 8 and a flat surface 8e parallel to the inner surface 4c of the lower disk portion 4b may be configured in an inside area of the bottom surface of the gasket 8. Note that, in FIG. 6, the inclined surface 8d is a curved surface which inclines outward at a predetermined constant elevation angle, but the inclined surface 8d may be modified to a curved surface configured such that an elevation angle is larger at the peripheral portion of the bottom surface of the gasket 8, and is smaller at a position closer to an inside edge of the gasket 8 like the bottom surface 8b shown in FIG. 5.

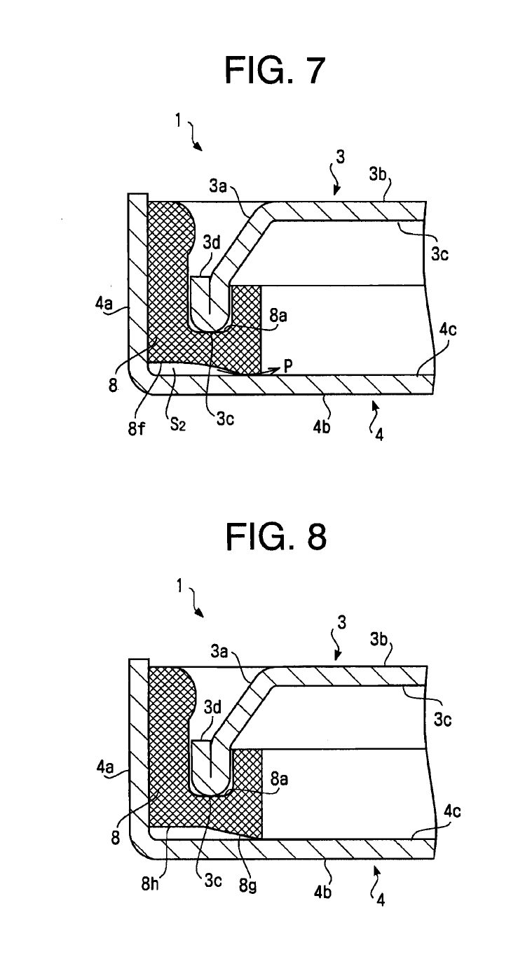

In the exemplary embodiment, the bottom surface 8b inclines outward with respect to the inner surface 4c of the lower disk portion 4b such that the distance from the inner surface 4c of the lower disk portion 4b is the smallest at the peripheral edge of the disk portion and the largest at the inside edge of the bottom surface of the gasket 8. Instead of such a configuration, the gasket 8 may be formed such that the bottom surface of the gasket 8 has an opposite inclination (i.e., the distance from the inner surface 4c of the lower disk portion 4b is the largest at the peripheral edge of the disk portion and the smallest at the inside edge of the bottom surface of the gasket 8), as shown in FIG. 7. According to such a modified configuration, the same effects as in the exemplary embodiment are expected. Specifically, when the wall 4a of the lower case 4 is bent, the gasket 8 is deformed such that the bottom surface 8f is pressed to tightly contact the inner surface 4c of the lower disk portion 4b and a space S2 formed between the bottom surface 8f and the inner surface 4c of the lower disk portion 4b disappears. As the bottom surface 8f is pressed, the electrolytic solution filled in the space S2 is extruded toward the central portion of the lower disk portion 4b as indicated with an arrow in FIG. 7 Note that, as shown in FIG. 7, the bottom surface 8f is a curved surface configured such that a depression angle is the smallest at the peripheral edge of the bottom surface 8f, the largest at the inside edge of the bottom surface 8f, and the depression angle monotonically increases from the peripheral edge to the inside edge of the bottom surface 8. It is noted that such a configuration can be modified such that the depression angle may be constant, i.e., the bottom surface of the gasket 8 has a truncated conical shape and the generating line of the truncated cone forms the depression angle. As shown in FIG. 8, the bottom surface of the gasket 8 may be configured such that an inside area of the bottom surface of the gasket 8 is formed to be an inclined surface 8g which inclines inward, and a peripheral area of the bottom surface of the gasket 8 is formed to be a flat surface 8h parallel to the inner surface 4c of the lower disk portion 4b.

What is claimed is:

1. An electrochemical cell comprising:
a first metal case having a first disk portion and a first wall protruding from a peripheral end of the first disk portion;
a second metal case having a second disk portion and a second wall protruding from a peripheral end of the second disk portion, a diameter of the second disk portion being larger than a diameter of the first disk portion, the first metal case being accommodated in the second metal case such that the first wall faces the second disk portion; and
a gasket having an annular upper surface, an annular bottom surface and a predetermined thickness, the gasket being interposed between the first metal case and the second metal case when the first metal case is accommodated in the second metal case,
wherein:
an outer circumference surface of the gasket contacts the second wall and a bottom surface of the annular gasket faces the second disk portion;
a circular groove is formed on the upper surface along its annular shape to receive an end portion of the first wall when the first metal case is accommodated in the second metal case;
the bottom surface of the gasket is formed such that one of an outer edge and an inner edge of the bottom surface contacts the second disk portion and the other of the outer edge and the inner edge of the bottom surface is spaced from the second disk portion by a predetermined distance, the bottom surface of the gasket being inclined with respect to the second disk portion; and
when an end portion of the second wall is bent toward the first wall with the first metal case being accommodated in the second metal case, the gasket is compressed between the first wall and the second wall and the bottom surface of the gasket contacts the second disk portion.

2. The electrochemical cell according to claim 1,
wherein the bottom surface of the gasket inclines with respect to the second disk portion at a predetermined angle before the end portion of the second wall is bent.

3. The electrochemical cell according to claim 2,
wherein the predetermined angle is within a range from 1° to 10°, inclusively.

4. The electrochemical cell according to claim 1,
wherein the bottom surface of the gasket inclines outwardly with respect to the second disk portion before the end portion of the second wall is bent.

5. The electrochemical cell according to claim 1,
wherein the bottom surface of the gasket inclines inwardly with respect to the second disk portion before the end portion of the second wall is bent.

6. The electrochemical cell according to claim 1,
wherein a flat surface parallel to the second disk portion is formed on a part of the bottom surface of the gasket before the end portion of the second wall is bent.

7. The electrochemical cell according to claim 1,
wherein the end portion of the first wall is folded toward the second wall to form a turnback portion.
